(19) United States
(12) Patent Application Publication
(10) Pub. No.: US 2009/0038323 A1
(43) Pub. Date: Feb. 12, 2009

(54) Method for Operating a Refrigerator, and a Refrigerator in Which the Compressor Is Switched On With a Time Delay

(75) Inventors: Thomas Guffler, Wittislingen (DE); Georg Hausmann, Dillingen (DE); Hans Ihle, Giengen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH ND SIEMENS HAUSGERATE GMBH, MUNCHEN (DE)

(21) Appl. No.: 12/085,289

(22) PCT Filed: Oct. 20, 2006
(86) PCT No.: PCT/EP2006/067623

§ 371 Date: May 20, 2008

(30) Foreign Application Priority Data
Nov. 30, 2005 (DE) 10 2005 057 149.2

(51) Int. Cl. G05D 23/32; G05B 15/00

(52) U.S. Cl. 62/158; 700/275

(57) ABSTRACT

A refrigeration device is provided and includes a compressor with a compressor inlet and a compressor outlet, an evaporator with an evaporator inlet and an evaporator outlet, a valve, connection lines, and a control unit. The compressor and the evaporator are part of a coolant circuit and the valve is arranged in the coolant circuit between the compressor outlet and the evaporator inlet. The compressor and the valve are actuated by the control unit, wherein the control unit has a delay unit which causes the compressor to be switched on with a time delay only after the valve is opened.

The invention relates to a refrigeration device, in particular a refrigerator, comprising a compressor with a compressor inlet and a compressor outlet, an evaporator with an evaporator inlet and an evaporator outlet, at least one valve, connection lines and a control unit, wherein the compressor and the evaporator are linked together by the connection lines in a fluid-conducting manner to form a coolant circuit, and the valve in the coolant circuit is arranged between the compressor outlet and the evaporator inlet, and wherein the compressor and the valve can be actuated by the control unit; and to a method for operating a refrigeration device, in particular a refrigerator, which features a compressor and an evaporator for compressing or evaporating a coolant respectively, wherein the compressor and the evaporator are linked together in a fluid-conducting manner to form a coolant circuit, such that the coolant can flow from a compressor outlet at the compressor to an evaporator inlet at the evaporator and from an evaporator outlet at the evaporator to a compressor inlet at the compressor.

EP 0 602 379 discloses such a refrigeration device, featuring a refrigerating machine and a heat-insulated housing, in which a system of evaporators that are linked via refrigerant lines is arranged. In the system of evaporators, the evaporators are individually arranged in thermally isolated compartments whose temperature can be influenced by a regulator arrangement that controls the refrigerant supply to the respective evaporator via a valve unit. The valve unit is used to allocate the refrigerant supply to the evaporators that are assigned to the respective compartments.

DE 696 28 506 T1 discloses a refrigerator comprising a compression unit, a condenser, an expansion apparatus and an evaporator, these being functionally interconnected by means of a cooling circuit in which a cooling medium is enclosed in a sealed manner, wherein the evaporator is embedded in a heat-insulating material which covers an internal chamber of the refrigerator. A shut-off valve is arranged between the compression unit and an expansion apparatus, and is opened by a controller when the compression unit is activated.

It is known that a valve can be arranged between a compressor outlet and an evaporator inlet in order to prevent a retrograde condensation of refrigerant from the compressor into the evaporator when the compression unit is switched off and the line section between compression unit and evaporator contains warm refrigerant. The valve is used to prevent the warm refrigerant from flowing into the evaporator and heating said evaporator.

The present invention addresses the problem of specifying a refrigeration device and a method for operating a refrigeration device, by means of which it is possible to achieve a reliable operation of the refrigerator and maximal efficiency.

This problem is solved in accordance with the invention by the refrigeration device and by the method for operating a refrigeration device as specified in the independent claims. Further advantageous embodiments and developments, which can be applied individually or combined as desired in a suitable manner in each case, are the subject matter of the respective dependent claims.

The refrigeration device according to the invention comprises a compressor with a compressor inlet and a compressor outlet, an evaporator with an evaporator inlet and an evaporator outlet, at least one valve, connection lines and a control unit, wherein the compressor and the evaporator are linked together by the connection lines in a fluid-conducting manner to form a coolant circuit, and the valve in the coolant circuit is arranged between the compressor outlet and the compressor inlet, and wherein the compressor and the valve are actuated or can be actuated by the control unit, wherein the control unit features a delay unit which has the effect that the compressor is switched on with a time delay only after the valve has been opened.

The refrigeration device is preferably a refrigerator and/or freezer and can have one or more cooling compartments, these being optionally maintained at different temperature levels. For this purpose, the refrigeration device features in particular a heat-insulated housing and at least one heat-insulated door. In a modification of the invention, the refrigeration device can also be a refrigerating device, in particular a climate control system such as e.g. a climate control system for motor vehicles.

A coolant such as e.g. a hydrocarbon such as isobutane is compressed with the aid of the compressor. The refrigerant can have a boiling point between −5° C. and −40° C., preferably between −15° C. and −30° C.

In particular, the compressor takes the form of a compression unit by means of which a gaseous refrigerant is pressurized. The compressed refrigerant is then supplied in particular to a heat exchanger such as e.g. a condenser, by means of which the energy that is introduced as a result of the compression process is released into a heat exchange medium such as e.g. air, in particular into the environment. For this purpose, the compressor usually interacts with a flow resistance such as e.g. a restrictor tube, in order to generate a higher pressure, usually between 4 and 10 bar, behind the compressor. As a result of the compression process and the subsequent temperature equalization of the coolant with the environment, a compressed coolant is provided at ambient temperature. The gaseous coolant can be converted to the liquid state of aggregation during the compression.

The coolant cools during a subsequent expansion due to the Joule-Thomson effect and/or the liquid-gas phase conversion, thereby producing the refrigeration performance of the refrigeration device. The pressure conditions, the quantity of coolant and the coolant itself are preferably selected such that liquefied coolant is supplied to the evaporator and evaporates in the evaporator during the subsequent expansion. The coolant is fed back to the compressor following the evaporation and absorption of heat.

The connection line between the compressor and the evaporator can be interrupted by means of the valve. The interruption serves to prevent a retrograde condensation of coolant at the compressor. As a result of this, the efficiency of the refrigeration device is significantly increased and the average energy consumption of the refrigeration device is significantly reduced.

The time delay between the opening of the shut-off valve and the activation of the compressor is used to assist, and under critical conditions even to ensure, the start-up of the compressor.

As a result of the premature opening of the valve, the refrigerant which is enclosed between the compressor and the valve, and is usually present in gaseous form under a high pressure if the compressor was switched off for an extended period, can flow into the evaporator, thereby reducing the pressure at the compressor. The reduced pressure on the pressure side of the compressor significantly assists the activation process of the compressor, such that the start-up of the compressor is ensured even under critical conditions, i.e. in the case of high ambient temperatures and weak current supply or low network voltage. This advantage can also be used for the purpose of reducing the size of the electric motor in the compressor. The premature opening allows smaller dimensioning of the electric motor due to the reduction of the required minimum starting torque. Moreover, the electric motor can also be designed such that it consumes less energy during use. Manufacturing costs, energy costs and operating costs can be saved in this way. In particular, the time delay is at least 0.5 seconds, preferably at least 1 second.

The flow resistance can take the form of a regulating valve or capillary tube.

The compressor is switched on for between 0.5 and 10 seconds, for example, in particular between 1 and 4 seconds.

The refrigeration device preferably comprises a voltage sensor for measuring a transient network voltage which is present at the refrigeration device. Using the voltage sensor, it is possible to determine the maximal power that can be received by the compressor or the compression unit.

The delay circuit is preferably configured such that the duration of the time delay is dependent on the measured network voltage, in particular the duration of the time delay is longer for a lower first network voltage than for a higher second network voltage. For example, the time delay is increased by one second if the transient network voltage deviates by 10% from the nominal network voltage. For example, the compressor is switched on two seconds after the valve opens instead of one second after the valve opens if a voltage of 207 V is measured in the case of a network having a nominal supply of 230 V. If a voltage of 184 V is measured, for example, the time delay is increased even further and the compressor is switched on only three seconds after the valve has been opened.

The time delay can depend on the transient network voltage in a continuous manner, but it can also increase incrementally or depend on said network voltage in an incremental manner.

In a further preferred embodiment of the invention, the refrigeration device further comprises a temperature sensor for measuring a transient ambient temperature of the refrigeration device. The refrigeration device can also comprise a sensor for measuring a transient temperature in or at the evaporator.

It is advantageous if the delay circuit is configured such that the duration of the time delay depends on the measured temperature, in particular the duration of the time delay is longer for a higher first temperature than for a lower second temperature. For example, the time delay can be lengthened by one second if the ambient temperature is above 30° C. If the ambient temperature is above 35° C., the time delay can be lengthened by a further second.

Provision is preferably made for a plurality of valves for a plurality of evaporators. In particular, a plurality of cooling circuits can be used for a plurality of temperature increments in this case. In particular, the refrigeration device features a plurality of cooling compartments, each featuring at least one evaporator.

The method according to the invention for operating a refrigeration device, in particular a refrigerator, which features a compressor and an evaporator for compressing or evaporating a coolant respectively, wherein the compressor and the evaporator are linked together in a fluid-conducting manner to form a coolant circuit, such that the coolant can flow from a compressor outlet at the compressor to an evaporator inlet at the evaporator and from an evaporator outlet at the evaporator to a compressor inlet at the compressor, comprises the following method steps: the coolant circuit between the compressor outlet and the evaporator inlet is interrupted and the compressor is switched off, then the coolant circuit between the compressor outlet and the compressor inlet is closed, and finally the compressor is switched on again with a time delay.

By virtue of the compressor switching on with a time delay, the pressure which the compressor must counteract is reduced since the pressure that exists between the compressor and the valve simply falls away as a result of the coolant flowing out into the evaporator. This assists the activation of the compressor, and in particular its electric motor during the start-up phase in which the motor (depending on motor type) does not or cannot yield its optimal power or maximal torque. The assisted activation process of the compressor also allows a smaller dimensioning of the motor. As a result of this, it is also possible to overcome problems when activating the compressor under adverse conditions such as e.g. high ambient temperature or in the case of a weak electrical current/voltage supply or energy supply.

As a result of the premature opening of the valve before the start-up of the compressor, it is possible to reduce production costs and operating costs and to improve the operational reliability of the refrigeration device.

It is advantageous if the transient network voltage which is present at the refrigeration device is measured and the duration of the time delay is selected depending on the measured network voltage, in particular if the duration of the time delay is selected to be longer for a lower first voltage than for a higher second network voltage. In this context, the following time delays are applicable:

In a specific embodiment, the time delay is increased continuously or incrementally by at least 0.5 seconds, in particular by at least 1 second, per 10% deviation in the measured network voltage below the nominal network voltage.

It is advantageous if the ambient temperature of the refrigeration device and/or a temperature at or in the evaporator is measured and the duration of the time delay is selected depending on the measured temperature, in particular if the duration of the time delay is selected to be longer for a higher first temperature than for a lower second temperature.

In a specific embodiment, the time delay is increased continuously or incrementally by at least 0.5 seconds, in particular by at least 1 second, per 5° C. deviation above 20° C.

As a result of these measures, it is possible to achieve a particularly high efficiency of the refrigeration device. Furthermore, as a result of the selected time delay the compressor can be operated in a favorable operating range, in which it has a particularly high efficiency, even if only limited power consumption is possible due to a weak transient network voltage at the relevant time.

Further advantageous particulars and embodiments, which can be applied individually or in any desired combination in each case, are explained in greater detail with reference to the following drawing, wherein said drawing is not intended to restrict the invention but merely to illustrate the invention in an exemplary manner.

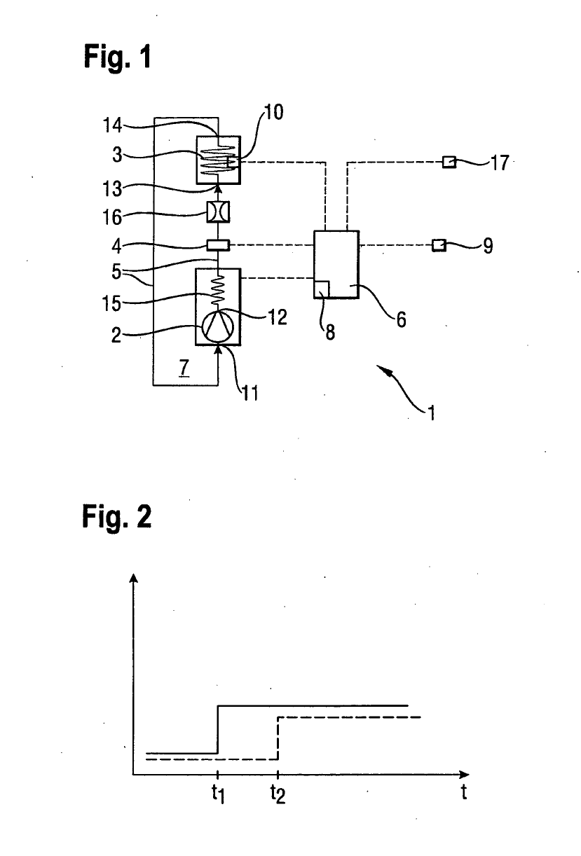

FIG. 1 schematically shows the refrigeration device according to the invention in the form of a circuit layout, and

FIG. 2 schematically shows a temporal course relating to the operation of the refrigeration device according to the invention.

FIG. 1 shows a refrigeration device 1 according to the invention, being designed in the form of a refrigerator and featuring a compressor 2 with a compressor inlet 11 and a compressor outlet 12, and an evaporator 3 with an evaporator inlet 13 and an evaporator outlet 14. The compressor 2 and the evaporator 3 are interconnected via connection lines 5 to form a coolant circuit 7, wherein a valve 4, a condenser 15 and a flow resistance 16 are arranged between the compressor 2 and the evaporator 3. The connection line 5 between the compressor outlet 12 and the evaporator inlet 13 can be shut off by means of the valve 4.

A coolant circulating in the coolant circuit 7 is compressed by the compressor 2, thereby raising the temperature of the coolant. The heat is then released into the environment, whereby the coolant liquefies due to the high pressure that is generated, between the flow resistance 16 and the compressor 2, by the flow resistance 16. The flow resistance is designed as a restrictor tube. The coolant is expanded in the evaporator 3 and cools as a result of this. The refrigeration content of the compressed coolant is then made available to a cooling compartment (not shown) of the refrigeration device 1. The expanded coolant which is warmed in the evaporator 3 is then fed back to the compressor 2.

The valve 4 and the compressor 2 are actuated by a control unit which is connected to a first 10 and a second 17 temperature sensor and to a voltage sensor 9. The valve 4 is used to avoid degradation of the efficiency of the refrigeration device 1 as a result of retrograde condensation of coolant from the switched-off warm compressor 2 into the evaporator 3 which is still cold.

The control unit 6 features a delay unit 8, by means of which the compressor 2 is switched on with a time delay only after the valve 4 has been opened. As a result of the premature opening of the valve 4 before the compressor 2 is switched on, the coolant which is stored under relatively high pressure between the compressor 2 and the valve 4 can expand into the evaporator 3, such that the compressor 2 need only counteract a lower pressure instead of the high pressure.

If the ambient temperature is less than 20°, the temperature at the evaporator 3 is less than a predetermined reference temperature, and the transient network voltage at the refrigeration device 1 is greater than 220 V, a delay of 1 second is selected for switching on the compressor 2 after the valve 4 has been opened. If the transient network voltage is 105 V, the delay time is increased by 1 second. If the ambient temperature is greater than 25°, the delay time is increased by a further second.

As a result of extending the delay time, it is possible to ensure reliable operation of the refrigeration device 1 under critical conditions such as e.g. high ambient temperatures or low transient network voltages, even during the critical phase of the start-up of the compressor. Moreover, the electric motor (not shown) in the compressor can be dimensioned such that it is smaller, less expensive and requires less energy.

FIG. 2 shows the switching status of the valve 4 (continuous line) and of the compressor 2 (broken line) relative to time. It can be seen that the switching-on of the compressor 2 is time-shifted by the time delay T=t₂−t₁ after the valve 4 has been opened.

The invention relates to a refrigeration device 1, in particular a refrigerator, comprising a compressor 2 with a compressor inlet 11 and a compressor outlet 12, an evaporator 3 with an evaporator inlet 13 and an evaporator outlet 14, at least one valve 4, connection lines 5 and a control unit 6, wherein the compressor 2 and the evaporator 3 are linked together by the connection lines 5 in a fluid-conducting manner to form a coolant circuit 7, and the valve 4 in the coolant circuit 7 is arranged between the compressor outlet 12 and the evaporator inlet 13, and wherein the compressor 2 and the valve 4 can be actuated by the control unit 6, wherein the control unit 6 features a delay unit 8 which has the effect that the compressor 2 is switched on with a time delay only after the valve 4 has been opened; and to a corresponding method for operating a refrigeration device 1.

The invention is characterized in that reliable operation of the refrigeration device 1 is ensured even during the start-up phase of the compressor 2, wherein greater efficiency and good energy consumption are achieved.

### LIST OF REFERENCE NUMERALS

1 Refrigeration device
2 Compressor
3 Evaporator
4 Valve
5 Connection lines
6 Control unit
7 Coolant circuit
8 Delay unit
9 Voltage sensor
10 First temperature sensor
11 Compressor inlet
12 Compressor outlet
13 Evaporator inlet
14 Evaporator outlet
15 Condenser
16 Flow resistance
17 Second temperature sensor

1-10. (canceled)

11. A refrigeration device, in particular a refrigerator, comprising a compressor with a compressor inlet and a compressor outlet, an evaporator with an evaporator inlet and an evaporator outlet, at least one valve, connection lines and a control unit, wherein the compressor and the evaporator are linked together by the connection lines in a fluid-conducting manner to form a coolant circuit, and the valve in the coolant circuit is arranged between the compressor outlet and the evaporator inlet, and wherein the compressor and the valve are actuated by the control unit, characterized in that the control unit features a delay unit which has the effect that the compressor is switched on with a time delay only after the valve has been opened.
